(19) United States
(12) Patent Application Publication
(10) Pub. No.: US 2015/0055754 A1
(43) Pub. Date: Feb. 26, 2015

(54) X-RAY INSPECTION METHOD AND X-RAY INSPECTION DEVICE

(71) Applicant: TOKYO ELECTRON LIMITED, Tokyo (JP)

(72) Inventor: Yasutoshi UMEHARA, Tokyo (JP)

(21) Appl. No.: 14/529,483

(22) Filed: Oct. 31, 2014

Related U.S. Application Data
(63) Continuation of application No. PCT/JP2013/062127, filed on Apr. 24, 2013.

(30) Foreign Application Priority Data
May 1, 2012 (JP) 2012-104953

(51) Int. Cl. G01N 23/04; G06T 7/00

(52) U.S. Cl. CPC G01N 23/04; G06T 7/0006; G06T 7/0065; G06T 2207/10116; G06T 2207/20024; G06T 2207/30148
USPC 378/62

(57) ABSTRACT

An X-ray inspection method which is capable of measuring a shape of an inspection object at a high speed in a non-destructive manner is provided. The X-ray inspection method includes: a simulation image generating process of generating simulation images of a plurality of transmission images having different shape parameters of an inspection object; an X-ray imaging process of capturing an X-ray transmission image transmitting the inspection object; and a shape estimating process of estimating a shape parameter of a simulation image whose evaluation value indicating a similarity with the X-ray transmission image satisfies predetermined conditions among the plurality of simulation images, as a shape of the inspection object.

### CROSS-REFERENCE TO RELATED APPLICATIONS

This application is a Continuation Application of PCT International Application No. PCT/JP2013/062127, filed Apr. 24, 2013, which claimed the benefit of Japanese Patent Application No. 2012-104953, filed May 1, 2012, the entire content of each of which is hereby incorporated by reference.

### TECHNICAL FIELD

The present invention relates to an X-ray inspection method and an X-ray inspection device for providing shape measurement of an inspection object based on an X-ray transmission image.

### BACKGROUND

With the recent evolution of semiconductor processes, various patterns formed in silicon wafers and so on have been increasingly miniaturized and densified. Various methods have been proposed for measuring and inspecting shapes of such miniaturized and densified patterns.

For example, semiconductor inspection method of counting the number of semiconductor cells promptly and correctly using a scanning electron microscope (SEM) are known. Also, a method of measuring and inspecting a shape of an inspection object such as a through-silicon via (TSV) formed in a silicon wafer using a SEM or an X-ray CT device are known.

However, for example, when the SEM is used to perform an inspection, there is a need to cut a silicon wafer by FIB (Focused Ion Beam) and there is a possibility that an error occurs in the dimensions of the measured shape due to a deviation between a cutting surface and a center of the inspection object. In addition, there is a possibility that a measurement error occurs due to exaggerated brightness by an edge charge-up effect or the like at the cutting surface in SEM observation. In addition, since an operation, such as cutting of a silicon wafer, is required in order to acquire a SEM image, it may be difficult to measure all of the multiple inspection objects.

In addition, for example, when an X-ray CT device is used to perform the inspection, there is a need to cut the silicon wafer into a size suitable for imaging, which causes difficulties, like the inspection by the SEM, and it may also be hard to measure all of the inspection objects. In addition, reproduction of a CT image requires an advanced and vast image processing algorithm, takes much time for measurement of shapes of the inspection object, and may increase the costs of application software or computer executing processes.

### SUMMARY

The present disclosure provides some embodiments of an X-ray inspection method and an X-ray inspection device which are capable of measuring a shape of an inspection object at a high speed in a non-destructive manner.

According to one embodiment of the present disclosure, there is provided an X-ray inspection method including: a simulation image generating process of generating simulation images of a plurality of transmission images having different shape parameters of an inspection object; an X-ray imaging process of capturing an X-ray transmission image transmitting the inspection object; and a shape estimating process of estimating a shape parameter of a simulation image whose evaluation value indicating a similarity with the X-ray transmission image satisfies predetermined conditions, among the simulation images, as a shape of the inspection object.

According to another embodiment of the present disclosure, there is provided an X-ray inspection method including: a simulation image generating process of generating a plurality of simulation images which is used for estimation of a shape of an inspection object based on an evaluation value indicating a similarity with an X-ray transmission image of the inspection object and has different shape parameters of the inspection object.

According to further another embodiment of the present disclosure, there is provided an X-ray inspection method including: an X-ray imaging process of capturing an X-ray transmission image of an inspection object; and a shape estimating process of estimating a shape parameter of a simulation image whose evaluation value indicating a similarity with the X-ray transmission image satisfies predetermined conditions among a plurality of simulation images having different shape parameters of the inspection object, as a shape of the inspection object.

According further another embodiment of the present disclosure, there is provided an X-ray inspection device including: a simulation image generating unit to generate simulation of a plurality of transmission images having different shape parameters of an inspection object; an X-ray imaging unit to capture an X-ray transmission image transmitting the inspection object; and a shape estimating unit to estimate a shape parameter of a simulation image whose evaluation value indicating a similarity with the X-ray transmission image satisfies predetermined conditions among the plurality of simulation images, as a shape of the inspection object.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a diagram illustrating a schematic configuration of an X-ray inspection device according to an embodiment.

FIG. 2 is a view illustrating an X-ray transmission image captured by an X-ray imager according to an embodiment.

FIG. 3 is a diagram illustrating a hardware configuration of an image processor according to an embodiment.

FIG. 4A is a diagram illustrating shape parameters of TSV in an embodiment.

FIG. 4B is a diagram illustrating shape parameters of TSV in an embodiment.

FIG. 5A is a view illustrating a simulation image generated based on shape parameters in an embodiment.

FIG. 5B is a view illustrating a simulation image generated based on shape parameters in an embodiment.

FIG. 6 is a diagram for explaining a method of generating a simulation image in an embodiment.

FIG. 7 is a flow chart showing a process of generating a simulation image by an image generating unit in an embodiment.

FIG. 8 is a flow chart showing a process of correcting image distortion by an image processing unit in an embodiment.

FIG. 9 is a view illustrating a checker board pattern used for image distortion correction in an embodiment.

FIG. 10 is a view illustrating simulation image distortion correction in an embodiment.

FIG. 11 is a flow chart showing a process of estimating a shape of an inspection object in an embodiment.

FIG. 12 is a view illustrating a super-resolution image and a reduced image generated from an X-ray transmission image by an X-ray imager in an embodiment.

FIG. 13 is a view illustrating a reduced image generated from an X-ray transmission image by an X-ray imager in an embodiment.

FIG. 14 is an exemplary flow chart showing a matching process in an embodiment.

FIG. 15 is a diagram illustrating a result of calculating a matching score in an embodiment.

FIG. 16 is a view illustrating a result of calculating a matching score of a reduced image in an embodiment.

FIG. 17 is a view for explaining image cutting-out of a super-resolution image in an embodiment.

FIG. 18 is a view showing an example of sobel filtering process of an X-ray transmission image in an embodiment.

FIG. 19 is a view showing an example of sobel filtering process of a simulation image in an embodiment.

FIG. 20 is a diagram showing an example of extracting a shape parameter from a sobel filter processed X-ray transmission image in an embodiment.

### DETAILED DESCRIPTION

Embodiments of the present disclosure will now be described in detail with reference to the accompanying drawings. In the following embodiments, although a method for measuring a shape of TSV formed in a silicon wafer as an inspection object is described, it is noted that the inspection object is not limited thereto.

### Configuration of X-ray Inspection Device 100

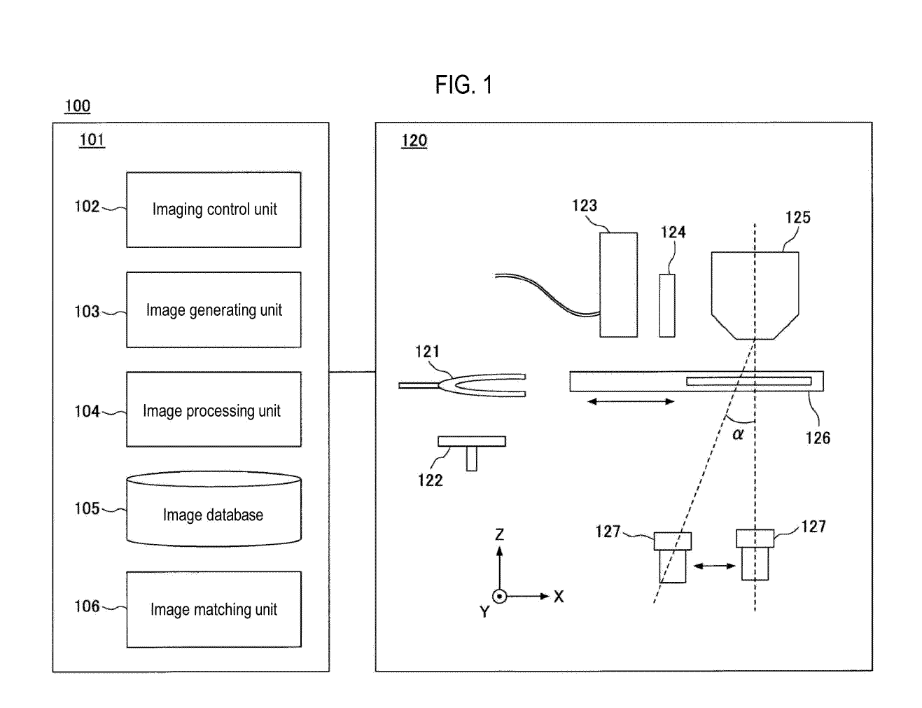

The configuration of an X-ray inspection device 100 according to an embodiment will be described. FIG. 1 is a diagram illustrating a schematic configuration of the X-ray inspection device 100 according to an embodiment.

As shown in FIG. 1, the X-ray inspection device 100 includes an image processor 101 and an X-ray imager 120. The X-ray imager 120 captures an X-ray transmission image (hereinafter, simply referred to as X-ray image) of an inspection object and the image processor 101 measures a shape of the inspection object by estimation based on the captured X-ray image of the inspection object.

The image processor 101 includes an imaging control unit 102, an image generating unit 103, an image processing unit 104, an image database 105, an image matching unit 106 and so on.

The imaging control unit 102 controls operations of all the elements including an X-ray source 125, a stage 126, an X-ray camera 127 and so on of the X-ray imager 120 for capturing an X-ray image of the inspection object, and acquires the X-ray image of the inspection object captured by the X-ray imager 120.

The image generating unit 103, which is an example of a simulation image generating means, generates X-ray images having different shapes of TSV in a silicon wafer as an inspection object through simulation. The image generating unit 103 generates simulation images of a plurality of transmission images based on shape parameters representing the TSV shapes. A method for generating the simulation images will be described later.

The image processing unit 104 performs image processing, such as distortion correction, contrast correction, resolution correction and so on, with respect to the simulation images generated by the image generating unit 103 or the X-ray images captured by the X-ray imager 120.

The image database 105 registers the simulation images, which are generated by the image generating unit 103 and subjected to the image processing by the image processing unit 104, with a library thereof.

The image matching unit 106, which is an example of a shape estimating means, performs a matching process upon the X-ray images captured by the X-ray imager 120 and the simulation images registered in the image database 105 to thereby estimate TSV shapes. A method for estimating the TSV shapes by the matching process will be described later.

The X-ray imager 120, which is an example of an X-ray imaging means, includes a fork 121, a notch aligner 122, an optical microscope 123, a thickness gauge 124, an X-ray source 125, a stage 126, an X-ray camera 127 and so on and is connected to the image processor 101. In the figure, an X direction corresponds to a horizontal direction parallel to a surface of the stage 126, a Y direction corresponds to a direction parallel to the surface of the stage 126 and perpendicular to the X direction, and a Z direction corresponds to a direction perpendicular to the surface of the stage 126.

In the X-ray imager 120, the fork 121 holds a silicon wafer having a TSV and the notch aligner 122 adjusts a notch position. The optical microscope 123 can observe an external appearance of the silicon wafer loaded on the stage 126. The thickness gauge 124, which is, for example, a gauge of a spectroscopic interference type, can measure a thickness of the silicon wafer.

The X-ray source 125 irradiates the silicon wafer loaded on the stage 126 with an X-ray, and the X-ray camera 127 installed in an opposite side of the X-ray source 125 across from the stage 126 interposed therebetween acquires an X-ray image of the silicon wafer.

The X-ray camera 127 includes, for example, an image intensifier, a CCD image sensor and so on, wherein the image intensifier converts an X-ray transmitting through an inspection object into visible light and the CCD image sensor converts incident visible light into an electrical signal. An output of the X-ray camera 127 is input to the imaging control unit 102 of the image processor 101, thereby being acquired as an X-ray image of the inspection object.

The X-ray camera 127 is movably installed in the XY direction in the figure. By moving the X-ray camera 127 in the XY direction, the X-ray image of the inspection object loaded on the stage 126 can be captured as a tilt image tilted by a predetermined angle a with respect to the Z direction, for example.

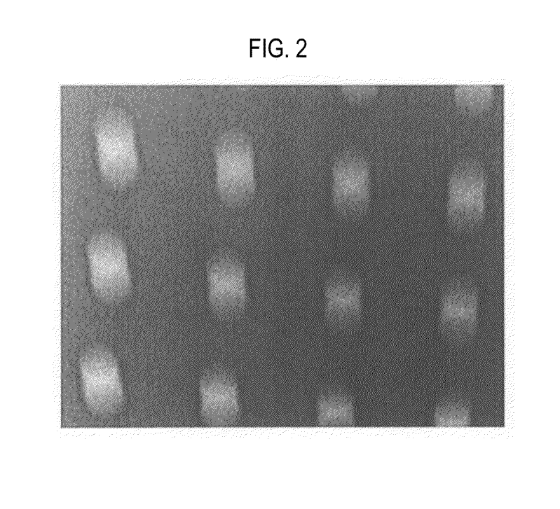

FIG. 2 illustrates an X-ray image captured by the X-ray imager 120 according to this embodiment.

FIG. 2 shows an X-ray image captured by the X-ray camera 127 in a direction tilted by 15° with respect to the Z direction. In this embodiment, a TSV shape is estimated using the tilted X-ray image capable of discriminating the whole shape of the TSV formed in the silicon wafer.

### Hardware Configuration of Image Processor

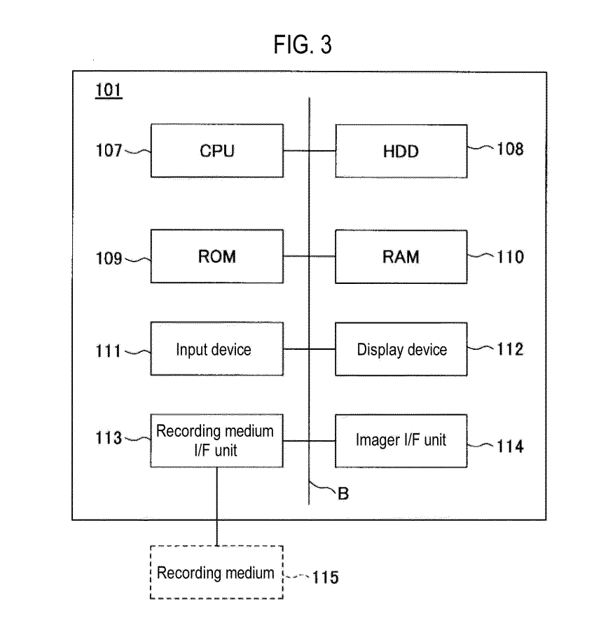

FIG. 3 is a diagram illustrating the hardware configuration of the image processor 101 according to an embodiment.

As shown in FIG. 3, the image processor 101 includes a CPU 107, a HDD (Hard Disk Drive) 108, a ROM (Read Only Memory) 109, a RAM (Random Access Memory) 110, an input device 111, a display device 112, a recording medium I/F unit 113, an imager I/F unit 114 and so on, all of which are interconnected via a bus B.

The CPU 107 is an operational unit configured to read out programs and data from a storage device such as the HDD 108 or the ROM 109 into the RAM 110 and processes them, thereby controlling the X-ray imager 120 and various functions of the image processor 101. The CPU 107 functions as the imaging control unit 102, the image generating unit 103, the image processing unit 104, the image matching unit 106 and so on.

The HDD 108 is a nonvolatile storage device storing programs or data. The stored programs or data include an OS (Operating System) as fundamental software controlling the entire image processor 101, application software providing various functions onto the OS, and so on. The HDD 108 functions also as the image database 105 in which the simulation images generated by the image generating unit 103 are registered.

The ROM 109 is a nonvolatile semiconductor memory (storage device) capable of retaining programs and data even when power is turned off. The ROM 109 stores programs and data such as BIOS (Basic Input/Output System) executed in booting of the image processor 101, OS settings, network settings, and so on. The RAM 110 is a volatile semiconductor memory (storage device) for temporarily retaining programs and data.

The input device 111 may include a keyboard, a mouse and so on and is used to input various operation signals to the image processor 101. The display device 112 may include a display and so on and displays X-ray images of the inspection object captured by the X-ray imager 120, simulation images, results of shape measurement, and so on.

The recording medium I/F unit 113 is an interface with a recording medium. The image processor 101 can read and/or write programs and data from and/or in the recording medium 115 through the recording medium I/F unit 113. The recording medium 115 may include a flexible disk, a CD, a DVD (Digital Versatile Disk), a SD memory card, a USB (Universal Serial Bus) memory and so on.

The imager I/F unit 114 is an interface accessing the X-ray imager 120. The image processor 101 can conduct data communication with the X-ray imager 120 through the imager I/F unit 114.

In addition, for data communication with other devices, the image processor 101 may be provided with a communication I/F or the like as an interface accessing a network.

### Generation of Simulation Image

Next, a method for generating simulation images by the image generating unit 103 of the image processor 101 will be described.

The image generating unit 103 of the image processor 101 generates a plurality of simulation images corresponding to the X-ray images captured by the X-ray imager 120 based on shape parameters of a TSV as an inspection object.

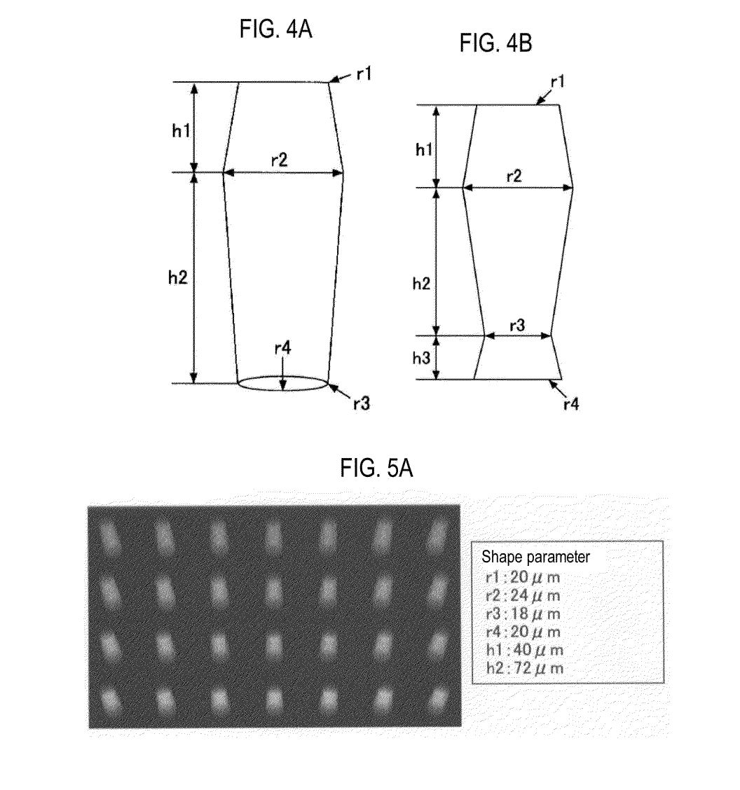

FIGS. 4A and 4B are diagrams illustrating shape parameters of a TSV in this embodiment.

In this embodiment, six parameters illustrated in FIG. 4A are used as shape parameters representing a shape of a TSV formed in a silicon wafer. In addition, positions of the X-ray camera 127 in the X and Y directions to determine a tilt angle a of an X-ray image are used as parameters. The TSV shape parameters in this embodiment include a diameter r1 of an opening, a maximum diameter r2 at an intermediate portion, a diameter r3 of a bottom portion, a diameter r4 of a portion etched into a semi-spherical shape at the bottom portion, a depth h1 from the opening up to the maximum diameter portion, and a depth h2 from the maximum diameter portion to the bottom portion, as shown in FIG. 4A. The type and number of parameters used to generate the simulation images are not limited to the above examples. For example, parameters may be set in association with the TSV shape as shown in FIG. 4B or may be appropriately set depending on a shape of an inspection object, a configuration of the X-ray imager 120, and so on.

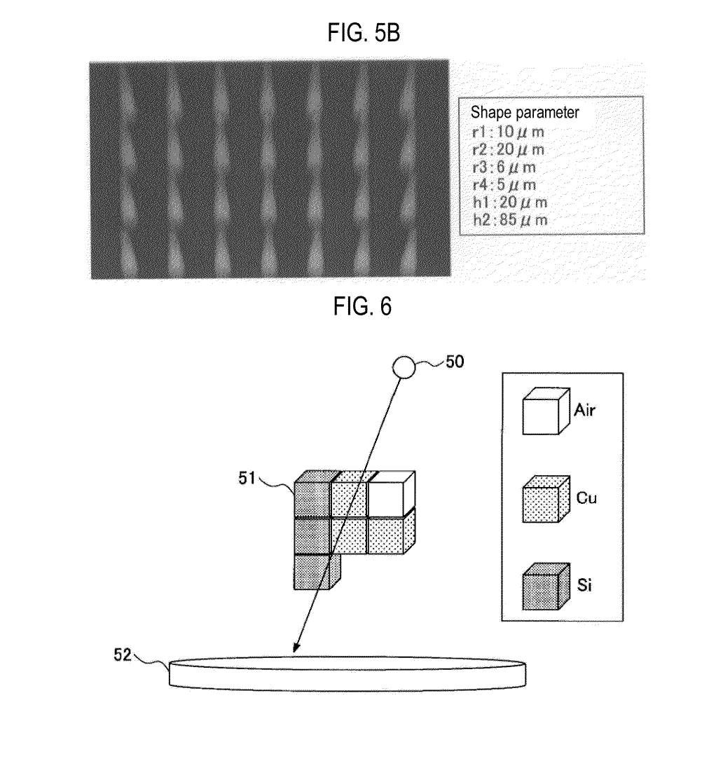

FIGS. 5A and 5B are views illustrating simulation images generated based on different shape parameters.

FIG. 5A shows a simulation image generated by the image generating unit 103 when shape parameters r1, r2, r3, r4, h1 and h2 are respectively set to 20 μm, 24 μm, 18 μm, 20 μm, 40 μm and 72 μm. FIG. 5B shows a simulation image generated by the image generating unit 103 when shape parameters r1, r2, r3, r4, h1 and h2 are respectively set to 10 μm, 20 μm, 6 μm, 5 μm, 20 μm and 85 μm.

As shown in FIGS. 5A and 5B, the image generating unit 103 can generate the simulation images corresponding to the X-ray images captured by the X-ray imager 120 based on different shape parameters.

FIG. 6 is a diagram for explaining a method for generating a simulation image in this embodiment.

When generating a simulation image, the image generating unit 103 generates aggregation formed by piling voxels 51 having different X-ray transmittances according to shape parameters, which are input first. Next, when the aggregation of voxels 51 is irradiated with an X-ray from the X-ray source 50 defined as a point light source, the amount of transmission of the X-ray is calculated based on the transmittance of each voxel 51 and an amount of X-ray reaching a detector 52 is reproduced as an image to thereby form a simulation image.

As shown in FIG. 6, the aggregation of voxels 51 is defined by material such as, for example, air, Cu, Si and the like, and the amount of X-ray transmitted through each voxels 51 and reaching the detector 52 is calculated using transmittances measured individually for these materials. The simulation image can be generated by assuming each voxel 51 as, for example, a 0.1 μm cube and setting transmittances of the voxels 51 as follows: for example, air: 1, Cu: 0.981/1 μm, and Si: 0.999/1 μm. The type, size and transmittance of the voxels are not limited to the above-mentioned values but may be appropriately set.

The image generating unit 103 calculates the amount of transmission of X-ray at the bottom of each voxel 51 sequentially from a voxel closer to the X-ray source 50 in the above settings, and computes the amount of X-ray reaching the detector 52 to thereby generate simulation images corresponding to the shape parameters, as shown in FIGS. 5A and 5B.

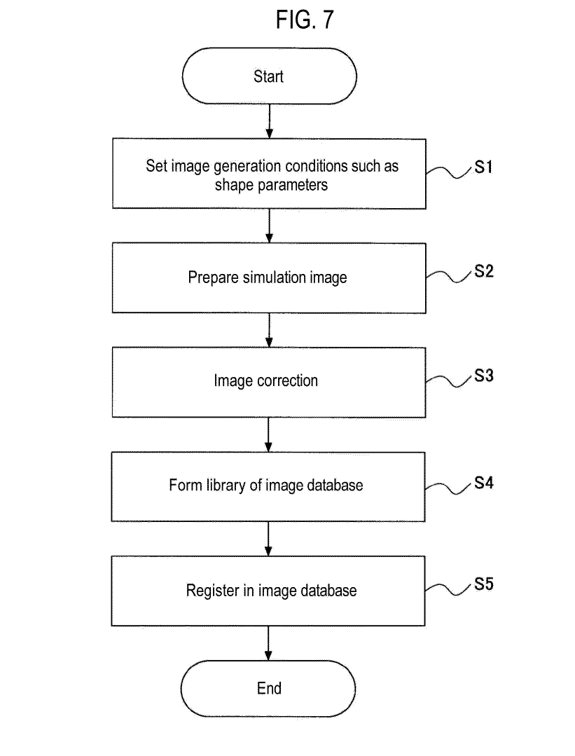

FIG. 7 is an exemplary flow chart showing a process of generating a simulation image by the image generating unit 103 in this embodiment.

The image generating unit 103 first sets a plurality of simulation generation conditions, such as the shape parameters r1, r2, r3, r4, h1 and h2 and a tilt angle (position of the X-ray cameras 127) at which an inspection object is imaged based on design values of TSV at Step S1. For example, the shape parameter r1 is set from 19 μm to 21 μm at a 0.1 μm interval based on a design value of 20 μm, as an image generation condition, and other shape parameters are set as different multiple image generation conditions.

Next, the image generating unit 103 generates a plurality of simulation images according to the above-described method based on the set plurality of image generation conditions at Step S2.

The image processing unit 104, which will be described later, performs an image correction process such as distortion correction or the like upon the generated simulation images in order to match the simulation images to the X-ray images captured by the X-ray imager 120 at Step S3.

Subsequently, a library of the plurality of generated simulation images, the shape parameters and the tilt angle at which the inspection object is imaged is formed at Step S4. The library-formed data are registered in the image database 105 and the processing of generating the simulation images is ended at Step S5.

The image generating unit 103 of the image processor 101 generates the plurality of simulation images having different shape parameters in advance according to the above-described process and registers them in the image database 105.

### Image Distortion Correction

Image distortion correction on the simulation images, which is performed by the image processing unit 104, will now be described.

X-ray images captured by the X-ray imager 120 of the X-ray inspection device 100 may have distortion at their peripheral portions, for example, due to an image intensifier of the X-ray camera 127. Accordingly, the image processing unit 104 performs image distortion correction on the generated simulation images in order to match them to the X-ray images captured by the X-ray imager 120.

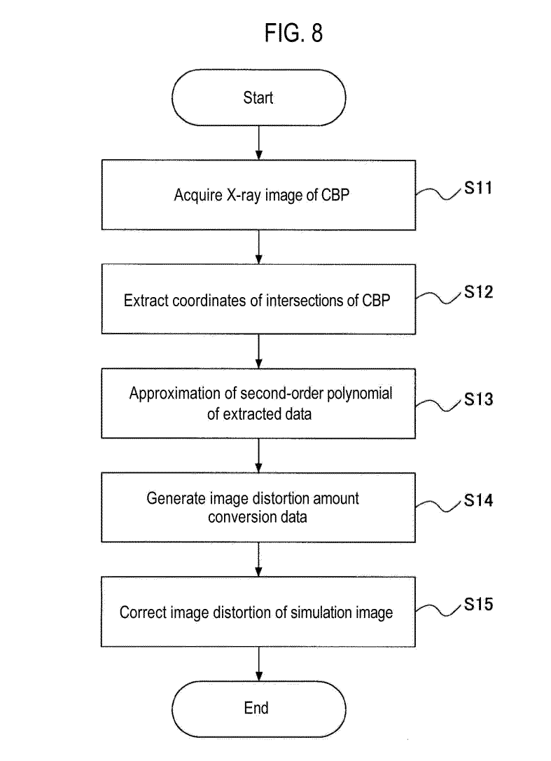

FIG. 8 is a flow chart showing a process of correcting image distortion by the image processing unit 104 in this embodiment.

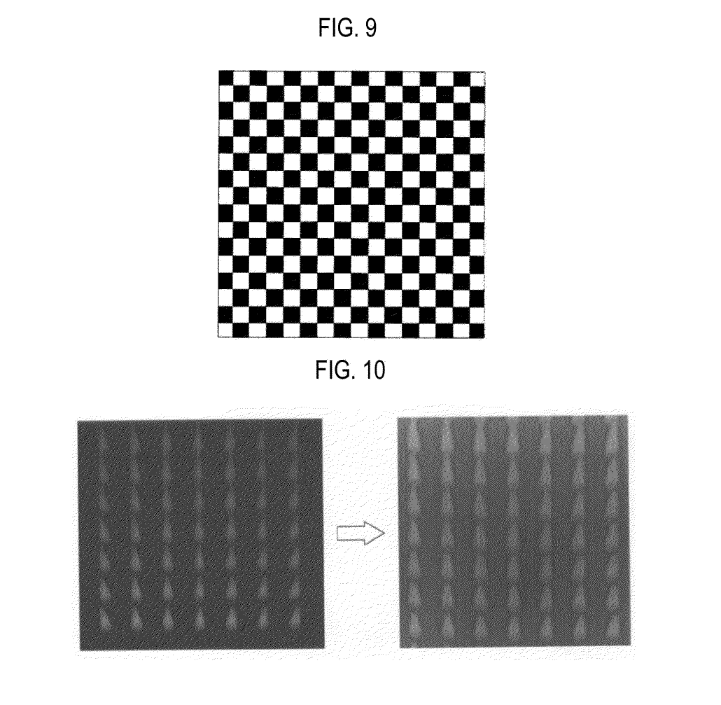

As shown in FIG. 8, first, an X-ray image of a checker board pattern (CBP) captured by the X-ray imager 120 is acquired at Step S11. The CBP is a sample formed by arranging materials having different transmission amounts of X-ray into a predetermined pattern, for example, as shown in FIG. 9. Next, XY coordinates of intersections of the materials having different transmission amounts of X-ray are extracted from the X-ray image of the CBP at Step S12.

Subsequently, for example, an approximation of second-order polynomial is obtained from the extracted XY coordinates of intersections at Step S13. At Step S14, based on the obtained approximation of a second-order polynomial, data for conversion of image distortion amounts are generated from a difference between coordinates of actual CBP intersections and the coordinates of intersections in the X-ray image.

Finally, at Step S15, based on the generated image distortion amount conversion data, the simulation images generated by the image generating unit 103 are subjected to image distortion correction and the process is ended.

FIG. 10 is a view illustrating simulation image distortion correction in an embodiment. In FIG. 10, a left image is a simulation image generated by the image generating unit 103 and a right image is an example of the simulation image subjected to image distortion correction.

As shown in FIG. 10, by subjecting the simulation image to the image correcting process and then matching it to an X-ray image captured by the X-ray imager 120, it is possible to estimate a shape of TSV as an inspection object with high precision.

In addition, CBP for obtaining an amount of distortion of the X-ray image by the X-ray imager 120 is sufficient if it can grasp the amount of distortion of the X-ray image, without being limited to the example shown in FIG. 9. In addition, although, in this embodiment, the simulation image generated by the image generating unit 103 is subjected to the image distortion correction, the X-ray image captured by the X-ray imager 120 may also be subjected to the image distortion correction.

### Estimation of Shape of Inspection Object

Next, a method for estimating a shape of TSV formed in a silicon wafer based on the X-ray image captured by the X-ray imager 120 and the simulation image generated by the image generating unit 103 will be described.

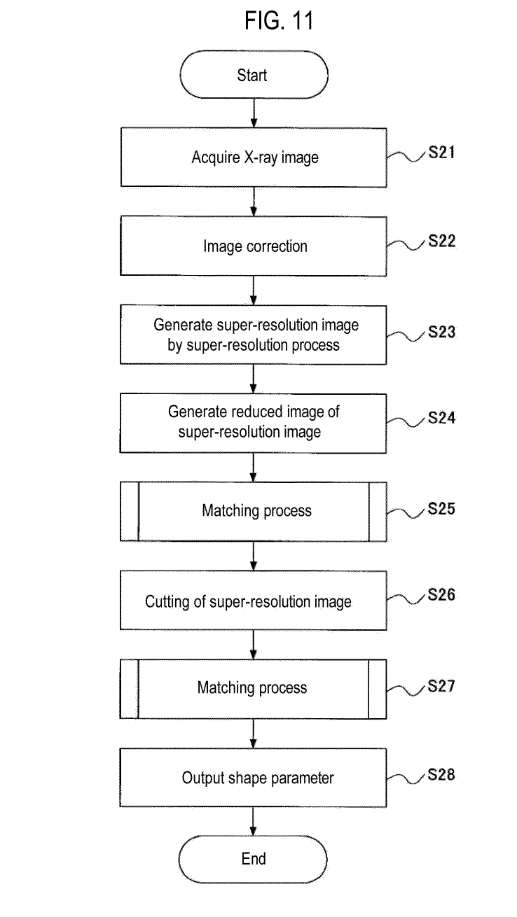

FIG. 11 is an exemplary flow chart showing a process of estimating a shape of an inspection object in this embodiment.

As shown in FIG. 11, first, the X-ray imager 120 captures an X-ray image of TSV formed in a silicon wafer at Step S21. Next, the image processing unit 104 of the image processor 101 performs image correction such as, for example, contrast correction, image distortion correction and the like on the captured X-ray image at Step S22.

Subsequently, the image processing unit 104 performs a super-resolution process on the X-ray image to thereby generate a super-resolution image at Step S23. A reduced image of the super-resolution image is generated at Step S24.

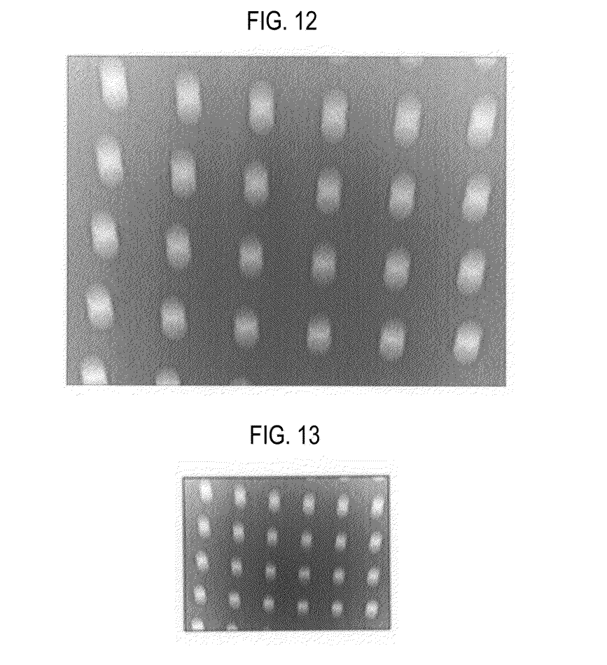

FIG. 12 illustrates a super-resolution image generated from an X-ray image by the X-ray imager 120 and FIG. 13 illustrates a reduced image of the super-resolution image.

For example, the super-resolution image is a 3770×2830 pixel image prepared from the X-ray image and the reduced image is a 377×283 pixel image which corresponds to 1/10 of the super-resolution image. It is also assumed that the image generating unit 103 generates simulation images having resolutions corresponding to the super-resolution image and the reduced image.

Next, the image matching unit 106 of the image processor 101 estimates a TSV shape parameter by matching the generated reduced image to a simulation image registered in the image database 105 at Step S25.

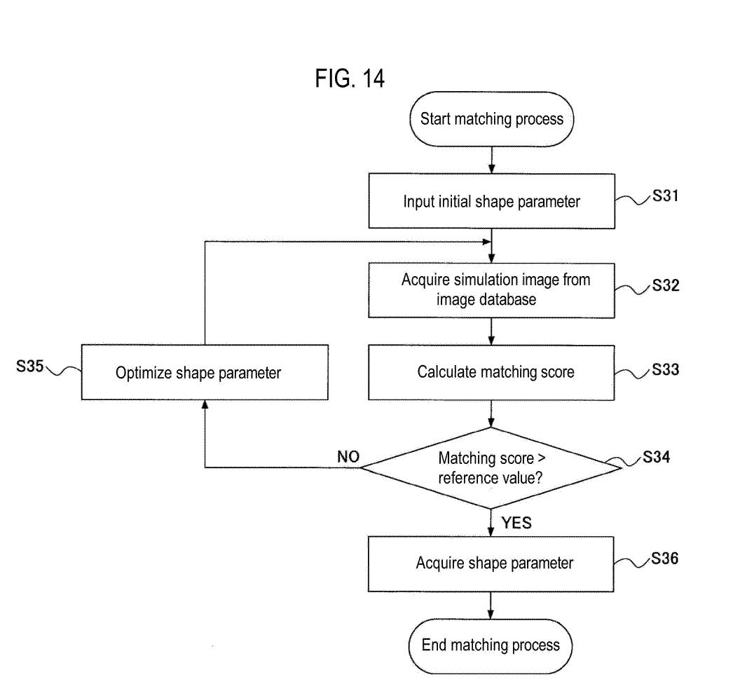

FIG. 14 is an exemplary flow chart showing a matching process in this embodiment.

In the matching process by the image matching unit 106, first, an initial shape parameter for estimation of the TSV shape parameter is input at Step S31. When the reduced image is used to perform the matching process, a design value of TSV and so on may be used as an example of the initial shape parameter.

Next, a simulation image of the input shape parameter is acquired from the image database 105 at Step S32. Subsequently, a matching score as an evaluation value indicating a similarity between the reduced image and simulation image of the X-ray image is calculated at Step S33. Although, in this embodiment, normalized correlation is used for calculation of the matching score, for example, geometric correlation, OCM (Orientation Code Matching) or the like may be used.

Next, the calculated matching score is compared with a reference value (e.g., 0.95) at Step S34. If the matching score is equal to or less than the reference value, the shape parameter is optimized at Step S35, a simulation image of the optimized shape parameter is acquired from the image database 105 again at Step S32, and a matching score is calculated at Step S33.

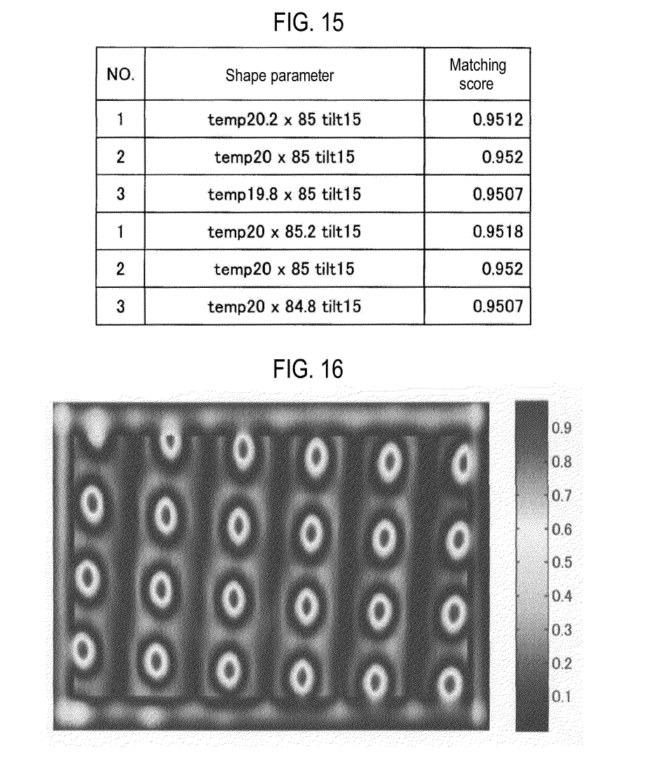

FIG. 15 illustrates a result of calculation of the matching score. As shown in FIG. 15, the simulation image of the input shape parameter is used to calculate the matching score, and if the matching score is equal to or less than the reference value, a simulation image having a different shape parameter is used to calculate a matching score again.

In the flow chart of the matching process shown in FIG. 14, the shape parameter is optimized by repeating Steps S32 to S35 until the matching score exceeds the reference value. For example, an optimization algorithm such as a genetic algorithm, a gradient method or the like may be used for optimization of the shape parameter at Step S35.

If the matching score exceeds the reference value at Step S34, the shape parameter is acquired at Step S36 and the process is ended.

Returning to the flow chart of the shape estimating process shown in FIG. 11, subsequently, TSV coordinate data having the highest matching score in the results of calculation of matching score of the reduced image are extracted and an image at a position corresponding to the coordinate data extracted is cut out from the super-resolution image at Step S26.

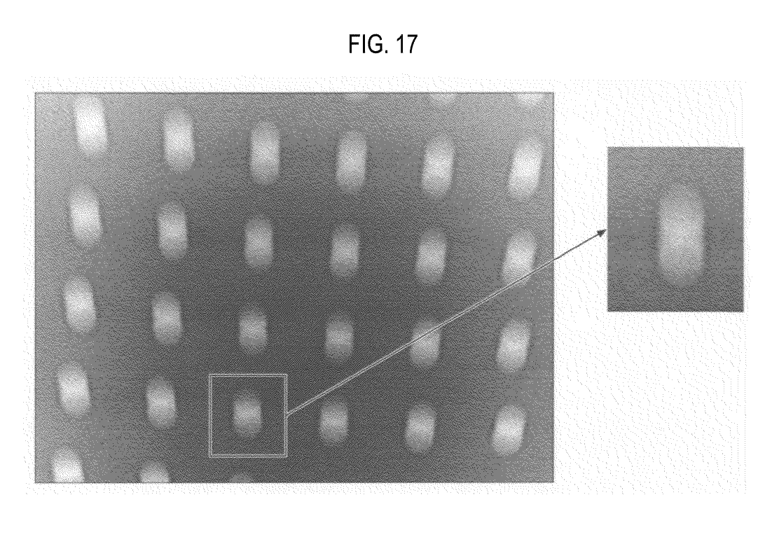

FIG. 16 is a view illustrating a result of calculation of a matching score between the reduced image and simulation image of the X-ray image. TSV coordinate data having a highest matching score are extracted from the result of calculation of matching score of the reduced image as shown in FIG. 16. As shown in FIG. 17, image data at a position corresponding to the coordinate data extracted are cut out of the super-resolution image.

Returning to the flow chart of the shape estimating process shown in FIG. 11, cutting of the super-resolution image is performed at Step S26 and then, an image cut out of the super-resolution image is used to perform the matching process.

In the matching process using the image cut out of the super-resolution image at Step S27, a shape parameter estimated using the reduced image is input as an initial shape parameter. As the shape parameter estimated using the reduced image is input as an initial condition, the estimation of the shape parameter can be performed at a higher speed.

Finally, the shape parameter acquired from the matching process by using the super-resolution image is output at Step S28 and the process is ended.

In this manner, in this embodiment, the super-resolution image and reduced image of the X-ray image are generated, the shape parameter is estimated based on the reduced image, and then, the shape parameter estimated from the reduced image is used to estimate the shape parameter based on the super-resolution image.

Since the reduced image has less image data than the super-resolution image, the matching process can be performed at a high speed. Therefore, it is possible to estimate the shape parameter in a shorter time than estimating the shape parameter using only the super-resolution image.

In addition, by estimating the shape parameter using an image partially cut out of the super-resolution image based on the result of calculation of matching score of the reduced image, it is possible to estimate the shape parameter at a higher speed than processing the entire super-resolution image.

In addition, according to this embodiment, it is possible to estimate a shape with a 0.1 μm resolution which corresponds to about 1/10 of a 1.0 μm resolution of the X-ray image acquired by the X-ray imager 120. Thus, it is possible to estimate a shape of an inspection object beyond a resolution of the X-ray imager 120.

### Estimation of Shape Parameter Using Filter Process

Next, a method for performing a filtering process on the X-ray image and the simulation image and estimating a shape parameter of an inspection object based on the X-ray image and simulation image with the filtering process performed will be described.

A sobel filtering process as an example of an edge emphasizing filter is performed on the X-ray image and the simulation image to thereby emphasize edges of the images.

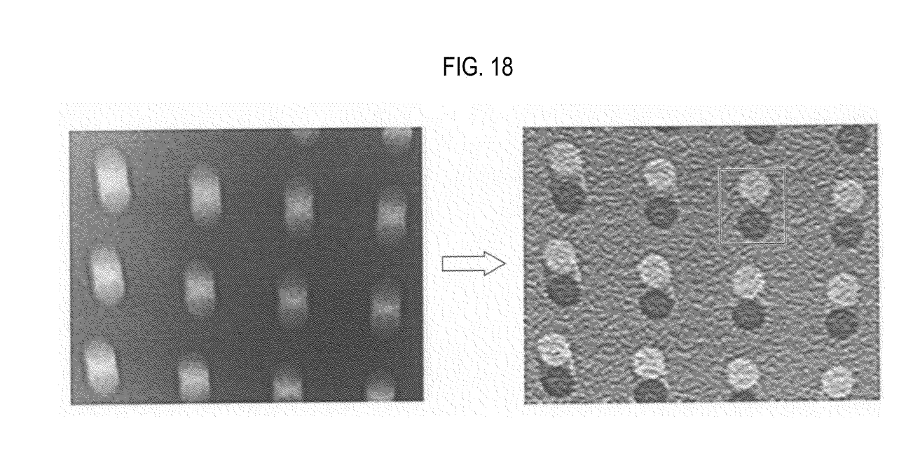

FIG. 18 is a view showing an example of performing the sobel filtering process on the X-ray image in this embodiment. In FIG. 18, a left image is an example of performing the sobel filtering process on the X-ray image in a depth direction of TSV and a right image is an X-ray image obtained after performing the sobel filtering process.

As can be seen from the X-ray image after performing the filtering process in FIG. 18, shapes of openings and bottoms of TSV are clearly shown in the image by subjecting the image to the sobel filtering process in the TSV depth direction.

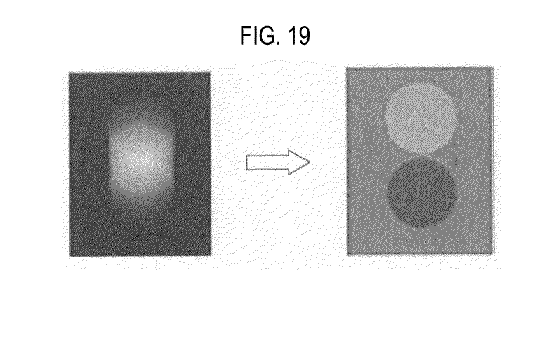

FIG. 19 shows an example of subjecting a simulation image to a sobel filtering process. Like FIG. 18, FIG. 19 shows an example of performing the sobel filtering process on the simulation image in the TSV depth direction. In FIG. 19, a left image is an image before the filtering process and a right image is an image after the filtering process is performed.

As can be seen from FIG. 19, like FIG. 18, shapes of openings and bottoms of TSV are clearly shown in the image.

By subjecting the X-ray image and simulation image to the sobel filtering process in this manner and performing a matching process using the sobel-filtered image, for example, the diameter r1 of the opening and the diameter r3 of the bottom portion among the shape parameters shown in FIG. 4A are estimated.

By using the X-ray image and simulation image whose opening and bottom of the TSV are emphasized by the sobel filtering process, it is possible to estimate the diameter r1 of the opening and the diameter r3 of the bottom portion among the shape parameters with high precision.

Thus, after obtaining the diameter r1 of the opening and the diameter r3 of the bottom portion in advance using the filtered image, other shape parameters are estimated by the matching process using the image before the filtering process. The other shape parameters can be estimated at a higher speed than estimating all shape parameters by the matching process at a time. Accordingly, by using the edge-emphasized image, it is possible to estimate the shape parameters with high precision and shorten an overall processing time taken to estimate the shape parameters.

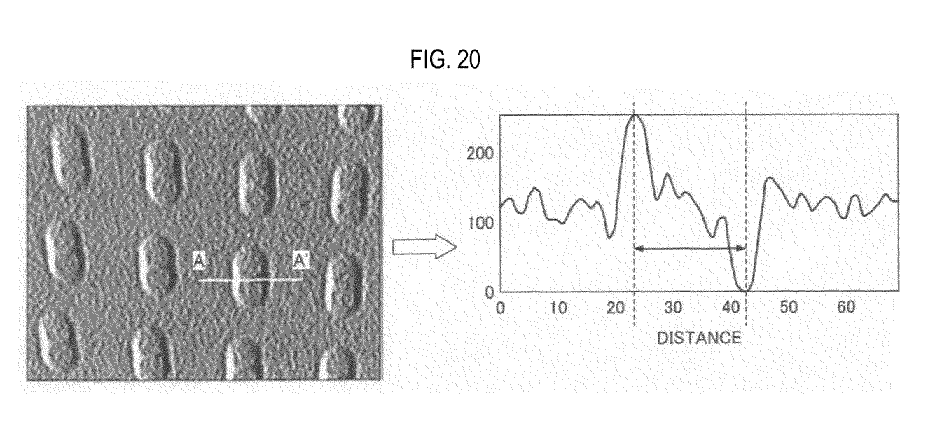

FIG. 20 is a view showing an example of extracting a shape parameter from an X-ray image in an embodiment. FIG. 20 illustrates a grayscale X-ray image with a sobel filtering performed in a TSV width direction and a profile of brightness values taken along line A-A′ in the X-ray image. A horizontal axis of the profile represents a pixel number, a vertical axis of the profile represents a brightness value, and the brightness value of each pixel is plotted by a number ranging from 0 to 255.

As shown in FIG. 20, by subjecting the X-ray image to the sobel filtering process in the TSV width direction, it is possible to obtain an image in which the maximum diameter r2 at the middle portion of the hall of the TSV among the shape parameters shown in FIG. 4A is emphasized.

Accordingly, like the X-ray image shown in FIG. 20, by subjecting the simulation image to the sobel filtering process in the TSV width direction and then the matching process, it is possible to estimate the TSV hall intermediate part maximum diameter r2 with high precision.

In addition, as shown in FIG. 20, the shape parameters can be also obtained by measuring the TSV hall intermediate part maximum diameter r2 from the X-ray image.

By performing the filtering process in this manner, it is possible to obtain the hall intermediate part maximum diameter r2 among the plurality of TSV shape parameters in advance. In addition, by reducing the number of shape parameters to be estimated by the matching process, it is possible to estimate TSV shapes in a short time.

As described above, according to this embodiment, it is possible to measure shapes of TSV as an inspection object with a high resolution and at a high speed in a non-destructive manner without cutting a silicon wafer.

The X-ray inspection method and the X-ray inspection device 100 according to this embodiment can be used for in-line testing in a semiconductor manufacturing process since shapes of an inspection object can be measured at a high speed and inspected without cutting.

In addition, when the in-line testing is performed in the semiconductor manufacturing process, it may be possible to install a server accessing image processors 101 of a plurality of X-ray inspection devices 100 via a network or the like and to configure the server to perform the matching process and so on. In this case, for example, the image database 105, the image matching unit 106 and so on may be installed in the server and the inspection can be collectively performed in the server, thereby providing intensive management of inspection results and so on.

According to an embodiment of the present disclosure, it is possible to provide an X-ray inspection method and an X-ray inspection device which are capable of measuring a shape of an inspection object at a high speed in a non-destructive manner.

Although some embodiments of the present disclosure have been described above, the present disclosure is not limited to the configuration illustrated herein, including the configuration illustrated in the above embodiments, the combinations with other elements, etc. Regarding these respects, various modifications may be made without departing from the spirit and scope of the disclosure and may be determined depending on types of applications.

What is claimed is:

1. An X-ray inspection method comprising:
a simulation image generating process of generating simulation images of a plurality of transmission images having different shape parameters of an inspection object;
an X-ray imaging process of capturing an X-ray transmission image transmitting the inspection object; and
a shape estimating process of estimating a shape parameter of a simulation image whose evaluation value indicating a similarity with the X-ray transmission image satisfies predetermined conditions among the plurality of simulation images, as a shape of the inspection object.

2. The X-ray inspection method of claim 1, further comprising an image generating process of generating a super-resolution image by a super-resolution process and a reduced image of the super-resolution image from the X-ray transmission image,
wherein the shape estimating process includes estimating the shape parameter using the reduced image and then estimating the shape parameter using the super-resolution image.

3. The X-ray inspection method of claim 1, wherein the simulation image generating process includes generating the simulation image by calculating an amount of transmission of the X-ray transmitting through aggregation formed by piling voxels having different X-ray transmittances, which is formed according to the shape parameter of the inspection object, based on the transmittances when the aggregation of voxels is irradiated with the X-ray.

4. The X-ray inspection method of claim 1, further comprising a filter processing process of subjecting the X-ray transmission image and the plurality of simulation images to an edge-emphasized filter process,
wherein the shape estimating process includes estimating at least one of the shape parameters based on the X-ray transmission image subjected to the edge-emphasized filter process.

5. The X-ray inspection method of claim 1, further comprising a distortion correction process of correcting distortion of the X-ray transmission image or the simulation image based on a result from X-ray imaging of a sample formed by arranging materials having different transmission amounts of an X-ray in a predetermined pattern.

6. The X-ray inspection method of claim 1, wherein the evaluation value is a value calculated by one of normalized correlation, geometric correlation and orientation code matching.

7. The X-ray inspection method of claim 1, wherein the shape estimating process includes estimating the shape parameter whose evaluation value satisfies the predetermined conditions, using an optimization algorithm.

8. The X-ray inspection method of claim 1, wherein the shape parameters are plurally set by corresponding to a solid shape of the inspection object.

9. The X-ray inspection method of claim 1, wherein the shape parameters includes shape parameters of a depth direction in which the X-ray is transmitted or shape parameters of a horizontal direction, which are distributed in the depth direction, by corresponding to a solid shape of the inspection object.

10. An X-ray inspection method comprising: a simulation image generating process of generating a plurality of simulation images which is used for estimation of a shape of an inspection object based on an evaluation value indicating a similarity with an X-ray transmission image of the inspection object and has different shape parameters of the inspection object.

11. An X-ray inspection method comprising:
an X-ray imaging process of capturing an X-ray transmission image of an inspection object; and
a shape estimating process of estimating a shape parameter of a simulation image whose evaluation value indicating a similarity with the X-ray transmission image satisfies predetermined conditions among a plurality of simulation images having different shape parameters of the inspection object, as a shape of the inspection object.

12. An X-ray inspection device comprising:
a simulation image generating unit to generate simulation of a plurality of transmission images having different shape parameters of an inspection object;
an X-ray imaging unit to capture an X-ray transmission image transmitting the inspection object; and
a shape estimating unit to estimate a shape parameter of a simulation image whose evaluation value indicating a similarity with the X-ray transmission image satisfies predetermined conditions among the plurality of simulation images, as a shape of the inspection object.
